(19) United States
(12) Patent Application Publication
(10) Pub. No.: US 2009/0268634 A1
(43) Pub. Date: Oct. 29, 2009

(54) COMMUNICATION APPARATUS, AND CONTROL METHOD AND COMPUTER PROGRAM FOR THE SAME

(75) Inventor: Hiroshi Mashimo, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/415,675

(22) Filed: Mar. 31, 2009

(30) Foreign Application Priority Data
Apr. 25, 2008 (JP) 2008-116299

(51) Int. Cl. H04L 12/28; H04J 3/08

(52) U.S. Cl. 370/254; 370/315

(57) ABSTRACT

A communication apparatus is provided. The apparatus comprises: a reception unit configured to receive an annunciation signal from a relay apparatus; a determination unit configured to, based on whether or not an address of another communication apparatus with which the communication apparatus is performing direct wireless communication is included in the annunciation signal, determine whether or not the relay apparatus is capable of relaying wireless communication between the communication apparatus and the other communication apparatus; and a switching unit configured to switch a path of the direct wireless communication with the other communication apparatus to a path via the relay apparatus determined by the determination unit as being capable of relaying the wireless communication.

### BACKGROUND OF THE INVENTION

1. Field of the Invention

The present invention relates to communication apparatuses, and control methods and computer programs for the same.

2. Description of the Related Art

In a wireless network employing a wireless transmission technology standardized by IEEE 802.11, there are a path through which terminal apparatuses directly communicate with each other, and a path through which they communicate with each other via a base station such as an access point.

Japanese Patent Laid-Open No. 2006-166313 discloses the following method of selecting between the above paths. That is, transmission path information is obtained and updated by periodically sending and receiving frames for the both communication paths, and based on the transmission path information, which of the direct transmission path and the indirect transmission path to select is determined.

The above proposal is to select a transmission path when a first transmission path and a second transmission path are known, that is, when a relay apparatus is already known. However, if the relay apparatus needed for the second transmission path is not yet determined, it is necessary to start with searching for the relay apparatus. The above proposal mentions nothing about the way of searching for the relay apparatus.

In addition, dummy data that would not be necessary needs to be periodically transmitted in order to select between the direct communication and the communication via the relay apparatus. This poses problems of a complicated selection procedure and a waste of wireless resources for the selection of the relay apparatus.

Thus, the present invention provides a technique for efficiently searching for a relay apparatus while efficiently utilizing wireless resources.

### SUMMARY OF THE INVENTION

According to one aspect of the present invention, a communication apparatus is provided. The apparatus comprises a reception unit configured to receive an annunciation signal from a relay apparatus, a determination unit configured to, based on whether or not an address of another communication apparatus with which the communication apparatus is performing direct wireless communication is included in the annunciation signal, determine whether or not the relay apparatus is capable of relaying wireless communication between the communication apparatus and the other communication apparatus, and a switching unit configured to switch a path of the direct wireless communication with the other communication apparatus to a path via the relay apparatus determined by the determination unit as being capable of relaying the wireless communication.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is an exemplary connection configuration diagram of a wireless communication system 100 in a first embodiment of the present invention;

FIG. 2 is an exemplary internal configuration of a wireless communication apparatus 200 in the embodiment of the present invention;

FIG. 3 is an exemplary internal configuration of a relay apparatus 103 in the embodiment of the present invention;

FIG. 4 is an exemplary configuration of a superframe 400;

FIG. 5A is a diagram describing a frame format of a BPOIE 500;

FIG. 5B is a diagram describing a frame format of a Bridge IE 550;

FIG. 6 is a flowchart showing an exemplary operation of the wireless communication system 100 in the first embodiment of the present invention;

FIG. 7 is a flowchart showing an exemplary operation of a wireless communication system 800 in a second embodiment of the present invention;

FIG. 8 is an exemplary connection configuration diagram of the wireless communication system 800 in the second embodiment of the present invention; and

FIG. 9 is a diagram showing an exemplary configuration of a relay apparatus list in the second embodiment of the present invention.

### DESCRIPTION OF THE EMBODIMENTS

Embodiments of the present invention will be described below with reference to the attached drawings.

### First Embodiment

In this embodiment, in which a transmitting apparatus 101, a receiving apparatus 102, and a relay apparatus 103 exist in the same wireless network, direct communication from the transmitting apparatus to the receiving apparatus is switched to communication via the relay apparatus when the direct communication is disconnected.

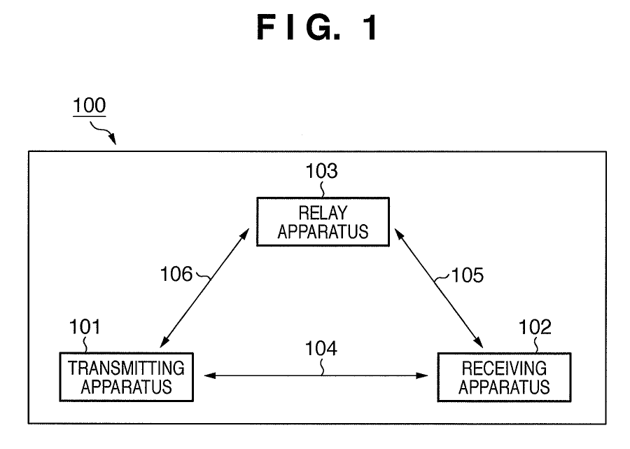

FIG. 1 shows an exemplary connection configuration diagram of a wireless communication system 100 in this embodiment. The transmitting apparatus 101, the receiving apparatus 102, and the relay apparatus 103 constitute the same wireless network capable of IP protocol communications according to WiMedia wireless transmission technologies. The relay apparatus 103 has a relay function for relaying between other apparatuses. Although this embodiment is described using the same wireless network, the present invention is applicable to wireless networks over which apparatuses can communicate broadcast signals with each other. A transmission path 104 is a path used in the direct communication between the transmitting apparatus 101 and the receiving apparatus 102. A transmission path 105 is used in the communication between the receiving apparatus 102 and the relay apparatus 103, and a transmission path 106 is used in the communication between the transmitting apparatus 101 and the relay apparatus 103. When the relay apparatus 103 operates as a relay apparatus for the communication between the transmitting apparatus 101 and the receiving apparatus 102, the transmission path 105 and the transmission path 106 are used instead of the transmission path 104.

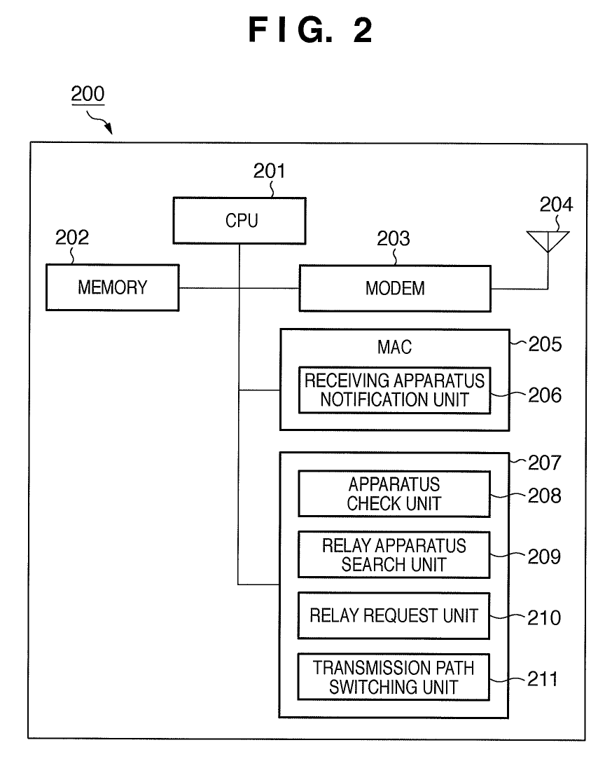

FIG. 2 shows an exemplary internal configuration of a wireless communication apparatus 200. Both the transmitting apparatus 101 and the receiving apparatus 102 are the wireless communication apparatuses 200. A CPU 201 performs control of the entire apparatus and data transmission/reception according to programs in a memory 202. The memory 202 stores apparatus control programs and transmission/reception data. The memory 202 also maintains the state of the relay apparatus 103 as will be described in a second embodiment. A modem 203 includes baseband and RF (Radio Frequency), and performs modulation/demodulation and conversion into wireless signals. An antenna 204 emits and receives RF signals through the air.

An MAC (Medium Access Control) 205 is a medium access control and performs medium control including generating frames such as for beacon signals in wireless zones. A receiving apparatus notification unit 206 extracts the address of a source apparatus of an annunciation signal received in the MAC 205 from the annunciation signal, and transmits an annunciation signal with the extracted address included therein. For example, in FIG. 1, the receiving apparatus 102 may receive an annunciation signal from the relay apparatus 103. In this case, the receiving apparatus notification unit 206 in the receiving apparatus 102 extracts the address of the relay apparatus 103 from the received annunciation signal and transmits an annunciation signal that includes this address. The transmitting apparatus 101 receives the annunciation signal from the receiving apparatus 102 and checks that the address of the relay apparatus 103 is included in the annunciation signal. Therefore, the transmitting apparatus 101 can recognize that the relay apparatus 103 and the receiving apparatus 102 can communicate with each other. In this manner, the wireless communication apparatus 200 can notify other wireless communication apparatuses that it is an apparatus capable of wireless communication with the relay apparatus 103. Although beacons will be used hereinafter as exemplary annunciation signals in this embodiment, it is to be understood that the present invention is applicable to not only beacons but any signals periodically communicated between apparatuses.

An LLC (Logical Link Control) 207 performs logical link control. An apparatus check unit 208 obtains, from an information element (IE) included in the received beacon, a list of apparatuses from which the source apparatus of the beacon has received beacons. The apparatus check unit 208 then checks whether the address of an intended apparatus maintained beforehand is included in this list. Here, an information element is an element of information that constitutes the beacon.

In this embodiment, the intended apparatus is the receiving apparatus 102 for the transmitting apparatus 101, and the transmitting apparatus 101 for the receiving apparatus 102. A relay apparatus search unit 209 searches for an apparatus having a relay function by using an information element included in the beacon received at the antenna 204. A relay request unit 210 transmits a relay request message to the relay apparatus 103. The transmitting apparatus 101 or the receiving apparatus 102 transmits the relay request message to the relay apparatus 103, thereby requesting that data transmitted by the transmitting apparatus 101 to the relay apparatus 103 through the transmission path 106 be transmitted by the relay apparatus 103 to the receiving apparatus 102 through the transmission path 105. A transmission path switching unit 211 switches from the direct communication to the communication via the relay apparatus 103 if the relay apparatus 103 responds to the relay request message with a relay acceptance message.

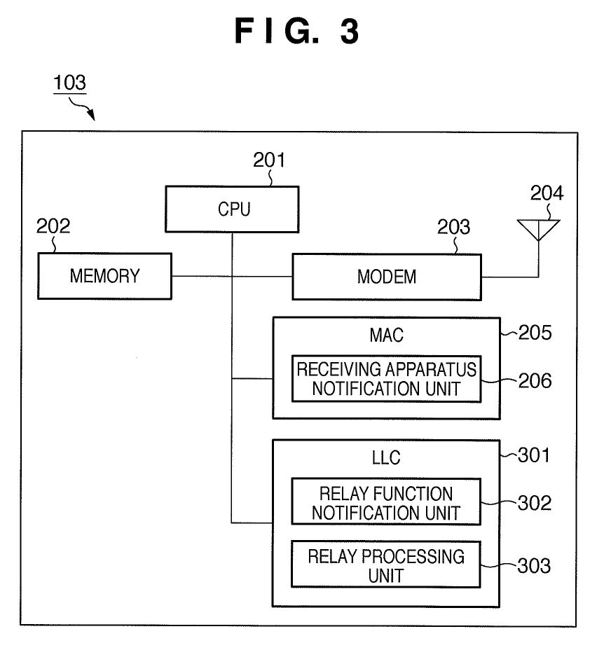

FIG. 3 shows an exemplary internal configuration of the relay apparatus 103. Portions similar to those of the wireless communication apparatus 200 are given like reference numerals and will not be described. A relay function notification unit 302 included in an LLC 301 adds a Bridge IE 550 indicating that the relay apparatus 103 has the relay function to a beacon to be transmitted by the relay apparatus 103, and broadcasts the beacon. The Bridge IE 550 will be described later.

A relay processing unit 303 checks a source apparatus of a signal received by the MAC 205 and then determines whether or not the signal is a relay request message. If the received signal is a relay request message and if the relay apparatus 103 can relay, the relay processing unit 303 transmits a relay acceptance message to the source apparatus and starts operation of relaying data from the source apparatus to a designated apparatus. For example, if a relay request message from the transmitting apparatus 101 to the receiving apparatus 102 is received, the relay processing unit 303 in the relay apparatus 103 temporarily holds data received from the transmitting apparatus 101 in the memory 202 and transmits the data to the receiving apparatus 102.

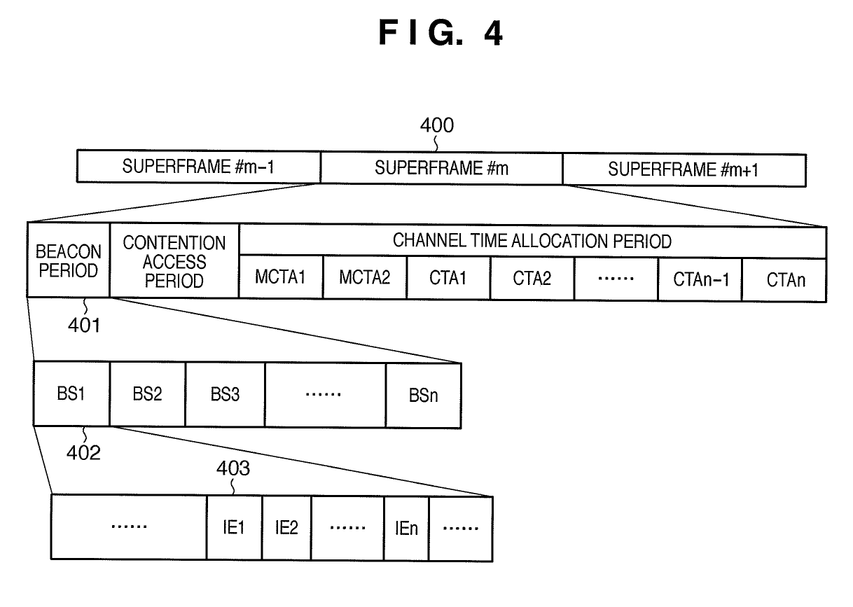

FIG. 4 is an exemplary configuration of a superframe 400 communicated by each apparatus in this embodiment. The superframe 400 includes a beacon period 401, a contention access period, and a channel time allocation period. Description will not be given except for the beacon period 401. The beacon period 401 is used by each apparatus to transmit a beacon directed to other apparatuses.

The beacon period 401 is divided into a plurality of beacon slots (BSs) 402. Each apparatus transmits its own beacon in a period corresponding to any one allocated beacon slot 402. The way of allocating the beacon slots 402 will not be described.

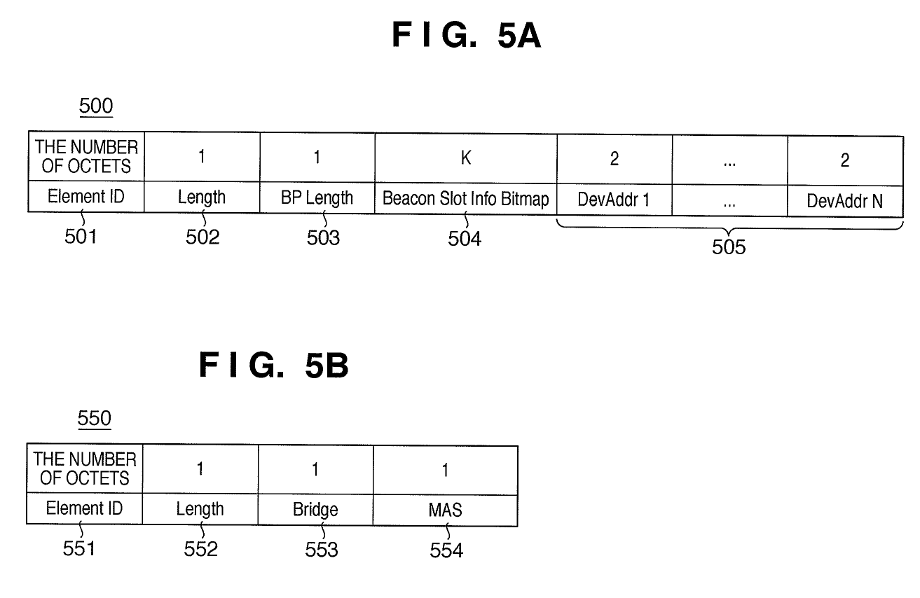

A beacon transmitted in the period of a beacon slot 402 includes a plurality of information elements (IEs) 403. Which information elements 403 are included depends on the type and state of the apparatus. Examples of the information elements 403 include a BPOIE 500 shown in FIG. 5A and a Bridge IE 550 shown in FIG. 5B.

FIG. 5A shows a frame format of the BPOIE (Beacon Period Occupancy Information Element) 500, which is an information element of a beacon transmitted by the receiving apparatus notification unit 206 in each MAC 205 of the transmitting apparatus 101, the receiving apparatus 102, and the relay apparatus 103. All beacons include the BPOIE 500 as an information element. While the BPOIE is generally used for reserving a beacon period, which is a slot in which each apparatus transmits a beacon, the BPOIE is used for searching for the relay apparatus in this description.

Element ID 501 is an identifier uniquely assigned to each information element of the beacon. If an information element is the BPOIE 500, an identifier indicating that it is the BPOIE 500 is contained in Element ID 501. Based on this Element ID 501, the BPOIE 500 can be extracted from the beacon. Length 502 indicates the length of the BPOIE 500. BP (Beacon Period) Length 503 indicates the length of the period in which the beacon is transmitted. Beacon Slot Info Bitmap 504 indicates the state of use of each slot available for beacon transmission. DevAddr 505 indicates source addresses of beacons received by the apparatus. Since DevAddr 505 concerns the sources of the received beacons, it does not contain the address of the apparatus itself.

FIG. 5B shows a frame format of the Bridge IE 550, which is an information element of a beacon broadcasted by the relay function notification unit 302 in the relay apparatus 103. The Bridge IE 550 is included only in beacons transmitted by the relay apparatus 103 and not in beacons transmitted by the wireless communication apparatus 200. By analyzing the Bridge IE 550, it can be determined whether or not the relay apparatus 103 is in the state capable of relaying.

Element ID 551 is an identifier uniquely assigned to each information element of the beacon. If the information element is the Bridge IE 550, an identifier indicating that it is the Bridge IE 550 is contained in Element ID 551. The value of Element ID 551 of the Bridge IE 550 is different from the value of Element ID 501 of the BPOIE 500. By determining whether or not a received beacon includes the Bridge IE 550, it can be determined whether or not the source apparatus is the relay apparatus 103. Length 552 indicates the length of the Bridge IE 550. Bridge 553 indicates the presence or absence of the relay function. MAS (Medium Access Slot) 554 indicates the number of free slots available for the relay apparatus as the relay function. If this value is 0, it indicates that the relay apparatus cannot relay because of the absence of available bands.

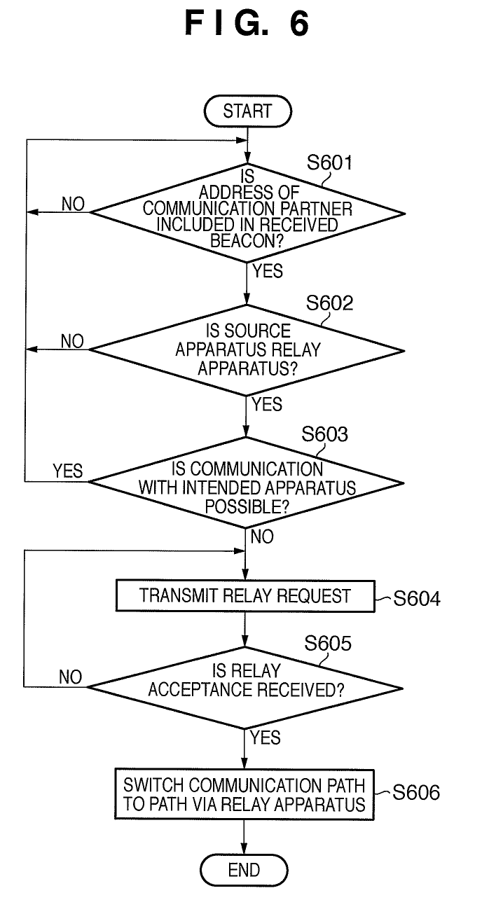

Now, an exemplary operation of selecting the relay apparatus will be described with reference to FIG. 6.

FIG. 6 is a flowchart showing an exemplary operation of selecting the relay apparatus in the transmitting apparatus 101 and the receiving apparatus 102. Processing in this flowchart is performed by the CPU 201 executing a program in the memory 202. Although the operation in the transmitting apparatus 101 will be described here, it also applies to the operation in the receiving apparatus 102. It is assumed that the transmitting apparatus 101 is communicating with or going to communicate with the receiving apparatus 102 before the start of the flowchart.

In step S601, it is determined whether or not the address of the communication partner is included in a received beacon. First, the transmitting apparatus 101 demodulates in the modem 203 the signal received at the antenna 204, and analyzes the header of the received data in the MAC 205. If it is determined from the header information that the received signal is a beacon, the receiving apparatus notification unit 206 extracts the BPOIE 500 from this beacon. The apparatus check unit 208 in the LLC 207 then determines whether or not the address of the receiving apparatus 102, that is, the intended apparatus, is contained in DevAddr 505 included in the BPOIE 500.

If the address of the receiving apparatus 102 is contained (“YES” in step S601), it means that the relay apparatus 103 can communicate with the receiving apparatus 102. Naturally, the relay apparatus 103 can also communicate with the transmitting apparatus 101 because the transmitting apparatus 101 has received the beacon from the relay apparatus 103. Therefore, if the relay apparatus 103 has the relay function and is in the state capable of relaying, the transmitting apparatus 101 and the receiving apparatus 102 should be able to communicate with each other via the relay apparatus 103. The process then transitions to step S602 to determine whether the relay apparatus 103 has the relay function.

If DevAddr 505 for the receiving apparatus 102 is not included (“NO” in step S601), it means that the relay apparatus 103 cannot communicate with the receiving apparatus 102. Therefore, the transmitting apparatus 101 cannot communicate with the receiving apparatus 102 via the relay apparatus 103. The transmitting apparatus 101 then returns to step S601 while continuing the direct communication with the receiving apparatus 102. If a failure occurs in the transmission path 104 at this stage, the transmitting apparatus 101 and the receiving apparatus 102 are unable to communicate with each other because communication is not possible even via the relay apparatus 103.

In step S602, the relay apparatus search unit 209 in the LLC 207 determines whether or not the Bridge IE 550 is included in the received beacon.

If the Bridge IE 550 is included and the value of Bridge 553 is 1 (“YES” in step S602), it means that the relay apparatus 103 has the relay function. The transmitting apparatus 101 then transitions to step S603 to determine the state of communication with the receiving apparatus 102.

If the Bridge IE 550 is not included in the beacon, or if the Bridge IE 550 is included but the value of Bridge 553 is 0 (“NO” in step S602), it means that the relay apparatus 103 does not have the relay function. Therefore, the transmitting apparatus 101 cannot communicate with the receiving apparatus 102 via the relay apparatus 103. The transmitting apparatus 101 then returns to step S601 while continuing the direct communication with the receiving apparatus 102.

In step S603, the transmitting apparatus 101 determines whether or not communication with the receiving apparatus 102 is possible. This determination may be based on the fact that the transmitting apparatus 101 has received a beacon from the receiving apparatus 102, or the fact that it has received data other than a beacon from the receiving apparatus 102.

If communication is possible (“YES” in step S603), it is not necessary to switch from the ongoing direct communication to the communication via the relay apparatus 103. Therefore, the process returns to step S601.

If communication is not possible (“NO” in step S603), the ongoing direct communication cannot be continued. Therefore, the process transitions to step S604 in order to switch to the communication via the relay apparatus 103.

In step S604, the relay request unit 210 in the transmitting apparatus 101 generates a relay request message directed to the relay apparatus 103 and transmits the relay request to the relay apparatus 103 from the antenna 204 via the modem 203.

In step S605, the transmitting apparatus 101 determines whether or not a relay acceptance message from the relay apparatus 103 is received.

If a relay acceptance message from the relay apparatus 103 cannot be received within a predetermined time period (“NO” in step S605), the process returns to step S604 to transmit a relay request message again. When the relay request has been made a predetermined times in step S604, it is determined that relaying is impossible and the flowchart terminates. In this case, the transmitting apparatus 101 and the receiving apparatus 102 are unable to communicate with each other because communication is not possible even via the relay apparatus 103.

If a relay acceptance message is received (“YES” in step S605), the transmission path switching unit 211 in the transmitting apparatus 101 switches the communication with the receiving apparatus 102 from the direct communication to the communication via the relay apparatus 103 in step S606. Thus, the transmitting apparatus 101 can communicate with the receiving apparatus 102 via the relay apparatus 103.

In the above description, it is checked in step S601 that the address of the receiving apparatus 102 is included in the beacon transmitted by the relay apparatus 103. Alternatively, the transmitting apparatus 101 may check that the address of the relay apparatus 103 is included in a beacon transmitted by the receiving apparatus 102, thereby determining that the relay apparatus 103 and the receiving apparatus 102 can communicate with each other.

Thus, as described above, by only determining the presence or absence of the relay function and the presence or absence of the address of the communication partner of communication included in the information elements of a received beacon, it can be readily determined whether communication via the source apparatus of this beacon is possible.

### Second Embodiment

In this embodiment, description will be given of application of the present invention to the case where a plurality of relay apparatuses exists in the same wireless network.

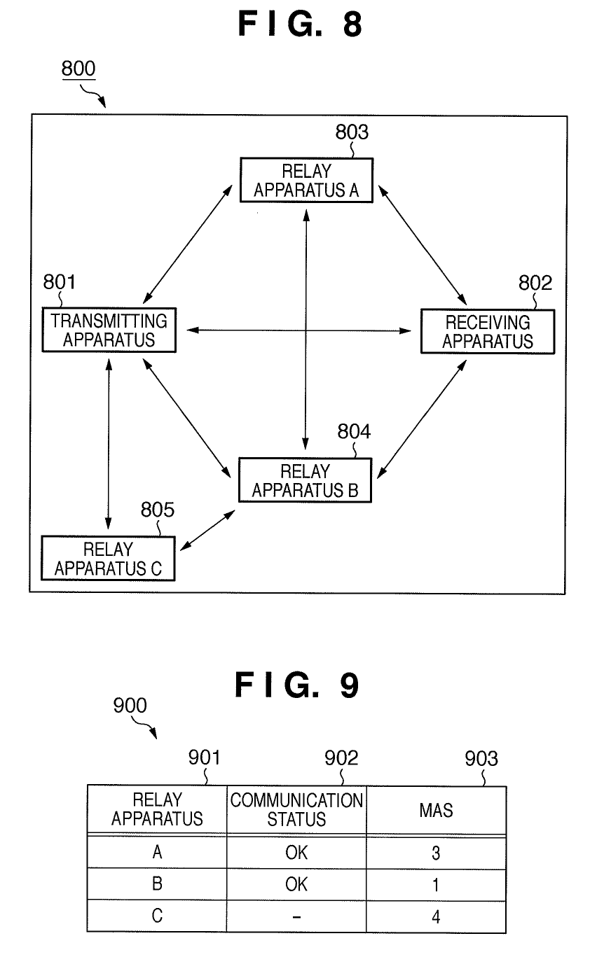

FIG. 8 shows an exemplary connection configuration diagram of a wireless communication system 800 in this embodiment. A transmitting apparatus 801, a receiving apparatus 802, and three relay apparatuses 803 to 805 exist. The transmitting apparatus 801 can receive beacons from the receiving apparatus 802, the relay apparatus A 803, the relay apparatus B 804, and the relay apparatus C 805. The receiving apparatus 802 can receive beacons from the transmitting apparatus 801, the relay apparatus A 803, and the relay apparatus B 804, but cannot receive a beacon from the relay apparatus C 805. The relay apparatus A 803 can receive beacons from the transmitting apparatus 801, the receiving apparatus 802, and the relay apparatus B 804, but cannot receive a beacon from the relay apparatus C 805. The relay apparatus B 804 can receive beacons from the transmitting apparatus 801, the receiving apparatus 802, the relay apparatus A 803, and the relay apparatus C 805. The relay apparatus C 805 can receive beacons from the transmitting apparatus 801 and the relay apparatus B 804, but cannot receive beacons from the receiving apparatus 802 and the relay apparatus A 803.

The relay apparatuses may be listed as the relay apparatus C 805, the relay apparatus A 803, and the relay apparatus B 804 in decreasing order of the number of free MASs available as the relay function.

The internal configuration of the transmitting apparatus 801, the receiving apparatus 802, and the relay apparatuses 803 to 805 are the same as in the first embodiment and therefore will not be described.

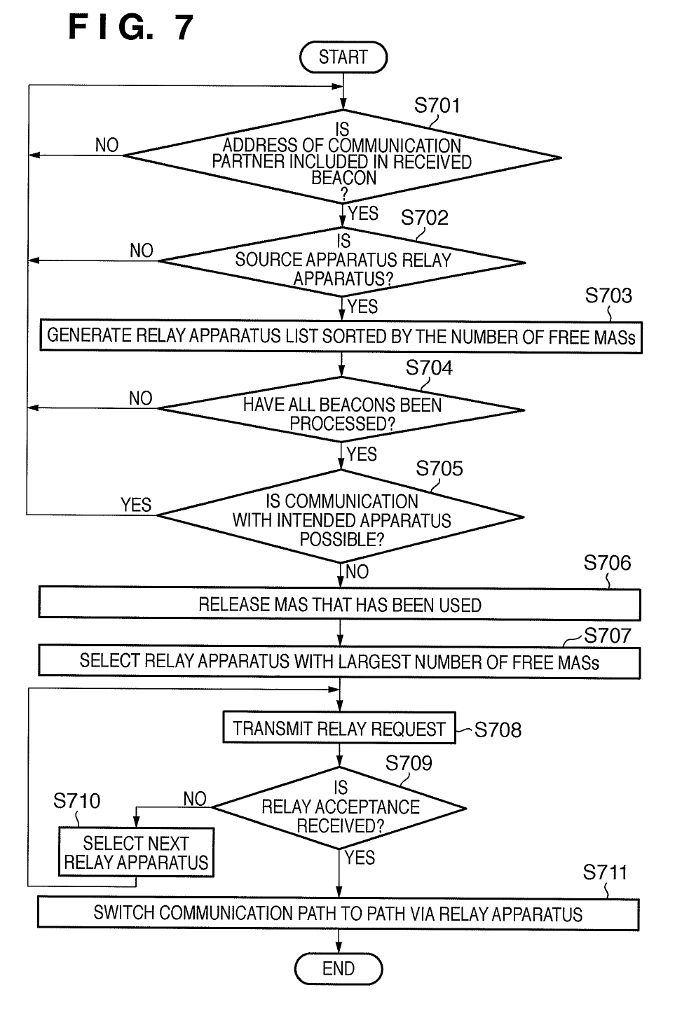

An exemplary operation of selecting a relay apparatus will be described with reference to FIG. 7.

FIG. 7 is a flowchart showing an exemplary operation of selecting a relay apparatus in the transmitting apparatus 801 and the receiving apparatus 802. Processing in this flowchart is performed by the CPU 201 executing a program in the memory 202. Although the operation in the transmitting apparatus 801 will be described here, it also applies to the operation in the receiving apparatus 802. Since the transmitting apparatus 801 can receive beacons from all the apparatuses 802 to 805, it receives beacons from all the apparatuses during one frame period. Although the description below will be given of the case where the beacons are received in an order that provides the best understanding of this embodiment, it is to be understood that the present invention is applicable to other orders. It is assumed that the transmitting apparatus 801 is communicating with or going to communicate with the receiving apparatus 802 before the start of the flowchart.

In step S701, it is determined whether or not the address of the communication partner is included in a received beacon. First, it is assumed that the transmitting apparatus 801 receives a beacon from the receiving apparatus 802. From the beacon received in the MAC 205 in the transmitting apparatus 801, the receiving apparatus notification unit 206 extracts the BPOIE. The apparatus check unit 208 in the LLC 207 then detects that DevAddr 505 in the BPOIE contains the addresses of the transmitting apparatus 801, the relay apparatus A 803, and the relay apparatus B 804. Since the beacon received now has been transmitted by the receiving apparatus 802, the address of the receiving apparatus 802 is not contained (“NO” in step S701). The process then returns to step S701.

Again in step S701, it is assumed that a beacon of the relay apparatus A 803 is now received. In the above manner, it is detected that DevAddr 505 contains the addresses of the transmitting apparatus 801, the receiving apparatus 802, and the relay apparatus B 804. The address of the receiving apparatus 802 is included this time (“YES” in step S701).

In step S702, the relay apparatus search unit 209 determines that the beacon includes the Bridge IE 550 and that Bridge 553 is 1 (“YES” in step S702).

Then, in step S703, a relay apparatus list is generated that includes the value of the number of available MASs indicated by MAS 554 and the address of the relay apparatus A 803. The relay apparatus list is maintained in the memory 202.

In step S704, it is determined whether or not the transmitting apparatus 801 has processed all the beacons included in one superframe 400. Since not all the beacons have been processed at this point (“NO” in step S704), the process returns to step S701.

In step S701, it is assumed that a beacon of the relay apparatus B 804 is now received. Processing similar to the above is performed, and in step S703, the transmitting apparatus 801 adds the address of the relay apparatus B 804 and the value of the number of available MASs to the relay apparatus list to be maintained in the memory 202. In step S704, still not all the beacons have been processed (“NO” in step S704) and therefore the process returns to step S701.

Again in step S701, it is assumed that a beacon of the relay apparatus C 805 is now received. This time, since the relay apparatus C 805 and the receiving apparatus 802 cannot communicate with each other, the address of the receiving apparatus 802 is not contained in DevAddr 505 (“NO” in step S701). The process then returns to step S701. Thus, the beacons for one superframe 400 have been received (“YES” in step S704). In this manner, the latest communication status between each of the relay apparatuses 803 to 805 and the receiving apparatus 802, and the latest value of the number of MASs available for each of the relay apparatuses 803 to 805 are maintained in the memory 202 of the transmitting apparatus 801.

FIG. 9 shows an exemplary configuration of the relay apparatus list at this point. FIG. 9 is a diagram showing an exemplary relay apparatus list 900. In FIG. 9, the relay apparatus list 900 registers information on Relay Apparatus 901, Communication Status 902, and MAS 903, respectively. Registered in Relay Apparatus 901 are “A,” “B,” and “C.” Registered in Communication Status 902 and MAS 903 is information about the relay apparatuses A to C, respectively. Since the relay apparatuses A 803 and B 804 can communicate with the receiving apparatus 802 in this embodiment, values reflecting such statuses are registered in Communication Status 902. Registered in MAS 903 are values of the number of free slots available for each relay apparatus as the relay function. In the example shown in FIG. 9, the relay apparatus C 805 has the largest value of the number of MASs.

In step S705, it is assumed that the transmitting apparatus 801 becomes out of communication with the receiving apparatus 802 (“NO” in step S705). The transmitting apparatus 801 then transitions to step S706 in order to switch to the communication via a relay apparatus.

In step S706, the relay request unit 210 in the transmitting apparatus 801 releases an MAS that has been used for the communication with the receiving apparatus 802.

In step S707, the transmitting apparatus 801 selects a relay apparatus with the largest number of free MASs from the relay apparatus list maintained in the memory 202. In this example, the relay apparatus A 803 is selected.

In step S708, the transmitting apparatus 801 transmits a relay request message to the relay apparatus A 803, requesting to relay data directed to the receiving apparatus 802.

In step S709, the transmitting apparatus 801 determines whether or not a relay acceptance message from the relay apparatus A 803 is received.

If a relay acceptance message response is received (“YES” in step S709), in step S711, the transmission path switching unit 211 in the transmitting apparatus 801 switches the communication with the receiving apparatus 802 from the direct communication to the communication via the relay apparatus A 803. Thus, the transmitting apparatus 801 can communicate with the receiving apparatus 802 via the relay apparatus A 803.

If a relay acceptance message is not received within a predetermined time period (“NO” in step S709), in step S710, the transmitting apparatus 801 selects a relay apparatus with the second largest number of free MASs from the relay apparatus list maintained in the memory 202 and returns to step S708. In this example, the relay apparatus B 804 is selected.

In step S708, the transmitting apparatus 801 transmits a relay request message to the relay apparatus B 804, requesting to relay data directed to the receiving apparatus 802.

If a relay acceptance message response is received (“YES” in step S709), the transmission path switching unit 211 in the transmitting apparatus 801 switches the communication with the receiving apparatus 802 from the direct communication to the communication via the relay apparatus B 804. Thus, the transmitting apparatus 801 can communicate with the receiving apparatus 802 via the relay apparatus B 804.

If no more relay apparatus can be selected in step S710, the selection is repeated again from the top of the list. If no relay acceptance message can be received after a predetermined times of repetition, it is determined that relaying is impossible and the flowchart terminates. In this case, the transmitting apparatus 801 and the receiving apparatus 802 are unable to communicate with each other because communication is not possible via any relay apparatus.

Thus, as described above, apparatuses capable of relaying are selected based on received beacons, and based on the information included in the beacons, a relay request is made to an apparatus in descending order of the number of bands available for relaying. Therefore, an appropriate relay apparatus can be selected.

### Other Embodiments

The above-described exemplary embodiments of the present invention can also be achieved by providing a computer-readable storage medium that stores program code of software (computer program) which realizes the operations of the above-described exemplary embodiments, to a system or an apparatus. Further, the above-described exemplary embodiments can be achieved by program code (computer program) stored in a storage medium read and executed by a computer (CPU or micro-processing unit (MPU)) of a system or an apparatus.

The computer program realizes each step included in the flowcharts of the above-mentioned exemplary embodiments. Namely, the computer program is a program that corresponds to each processing unit of each step included in the flowcharts for causing a computer to function. In this case, the computer program itself read from a computer-readable storage medium realizes the operations of the above-described exemplary embodiments, and the storage medium storing the computer program constitutes the present invention.

Further, the storage medium which provides the computer program can be, for example, a floppy disk, a hard disk, a magnetic storage medium such as a magnetic tape, an optical/magneto-optical storage medium such as a magneto-optical disk (MO), a compact disc (CD), a digital versatile disc (DVD), a CD read-only memory (CD-ROM), a CD recordable (CD-R), a nonvolatile semiconductor memory, a ROM and so on.

Further, an OS or the like working on a computer can also perform a part or the whole of processes according to instructions of the computer program and realize functions of the above-described exemplary embodiments.

In the above-described exemplary embodiments, the CPU jointly executes each step in the flowchart with a memory, hard disk, a display device and so on. However, the present invention is not limited to the above configuration, and a dedicated electronic circuit can perform a part or the whole of processes in each step described in each flowchart in place of the CPU.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-116299, filed Apr. 25, 2008 which is hereby incorporated by reference herein in its entirety.

What is claimed is:

1. A communication apparatus comprising:
a reception unit configured to receive an annunciation signal from a relay apparatus;
a determination unit configured to, based on whether or not an address of communication partner with which the communication apparatus is performing direct wireless communication is included in the annunciation signal, determine whether or not the relay apparatus is capable of relaying wireless communication between the communication apparatus and the communication partner; and
a switching unit configured to switch a path of the direct wireless communication with the communication partner to a path via the relay apparatus determined by said determination unit as being capable of relaying the wireless communication.

2. The apparatus according to claim 1, further comprising:
a request unit configured to request the relay apparatus to relay the wireless communication with the communication partner in case that the direct wireless communication with the communication partner cannot be continued, wherein
said switching unit switches the path of the wireless communication with the communication partner to the path via the relay apparatus if relaying of the communication by the relay apparatus is accepted.

3. The apparatus according to claim 2, further comprising:
an extraction unit configured to extract, if a plurality of relay apparatuses exists, information about the number of free slots available for each relay apparatus from a plurality of annunciation signals received from the plurality of relay apparatuses, wherein
a relay apparatus to be requested to relay is determined based on the number of free slots, and in case that the wireless communication with the communication partner cannot be continued, said request unit requests the relaying of the determined relay apparatus.

4. The apparatus according to claim 1, wherein the annunciation signal is a beacon signal that includes at least the presence or absence of a relay function in the relay apparatus and addresses of communication apparatuses capable of wireless communication with the relay apparatus.

5. The apparatus according to claim 1, wherein the communication apparatus determines whether the annunciation signal is a signal transmitted from the relay apparatus based on the annunciation signal received by said reception unit.

6. A control method for a communication apparatus, comprising:
receiving an annunciation signal from a relay apparatus;
determining, based on whether or not an address of communication partner with which the communication apparatus is performing direct wireless communication is included in the annunciation signal, whether or not the relay apparatus is capable of relaying wireless communication between the communication apparatus and the communication partner; and
switching a path of the direct wireless communication with the communication partner to wireless communication via the relay apparatus determined at said determining as being capable of relaying the wireless communication.

7. The method for the communication apparatus according to claim 6, further comprising:
requesting the relay apparatus to relay the wireless communication with the communication partner in case that the direct wireless communication with the communication partner cannot be continued, wherein
said switching comprises switching the path of the wireless communication with the communication partner s to the path via the relay apparatus if relaying is accepted by the relay apparatus.

8. The method for the communication apparatus according to claim 7, further comprising:
extracting information about the number of free slots available for each relay apparatus from a plurality of annunciation signals received from a plurality of relay apparatuses, wherein
said requesting comprises, if the wireless communication with the communication partner cannot be continued, requesting the relaying of a relay apparatus selected based on the number of free slots out of relay apparatuses determined as being capable of relaying the wireless communication.

9. The method for the communication apparatus according to claim 6, wherein the annunciation signal is a beacon signal that includes at least the presence or absence of a relay function in the relay apparatus and addresses of communication apparatuses capable of wireless communication with the relay apparatus.

10. The method for the communication apparatus according to claim 6, wherein whether the annunciation signal is a signal transmitted from the relay apparatus is determined based on the received annunciation signal.

11. A storage medium having stored thereon a computer program for causing a computer to function as the apparatus according to claim 1.

12. A communication apparatus comprising:
a reception unit configured to receive an annunciation signal from a second apparatus different from a first apparatus with which the communication apparatus is performing direct wireless communication;
a determination unit configured to determine whether or not identification information about the first apparatus is included in the annunciation signal received by said reception unit; and
a switching unit configured to switch a path of the direct wireless communication with the first apparatus to a path via the second apparatus that has transmitted the annunciation signal in which the identification information about the first apparatus is included.

13. A control method for a communication apparatus, comprising:
determining whether or not identification information about a first apparatus with which the communication apparatus is performing direct wireless communication is included in an annunciation signal from a second apparatus different from the first apparatus; and
switching a path of the direct wireless communication with the first apparatus to a path via the second apparatus that has transmitted the annunciation signal in which the identification information about the first apparatus is included.
